(19) United States
(12) Patent Application Publication
(10) Pub. No.: US 2014/0132837 A1
(43) Pub. Date: May 15, 2014

(54) WIRELESS VIDEO/AUDIO DATA TRANSMISSION SYSTEM HAVING I-FRAME ONLY GOP STRUCTURE

(71) Applicant: CYWEE GROUP LIMITED, TORTOLA (VG)

(72) Inventors: Zhou Ye, Foster City, CA (US); Wenxiang Dai, Taipei City (TW)

(73) Assignee: CYWEE GROUP LIMITED, TORTOLA (VG)

(21) Appl. No.: 14/147,590

(22) Filed: Jan. 6, 2014

Related U.S. Application Data
(63) Continuation-in-part of application No. 13/225,485, filed on Sep. 5, 2011.

(51) Int. Cl. H04N 5/08

(52) U.S. Cl. CPC H04N 5/08
USPC 348/525

(57) ABSTRACT

A wireless video/audio transmission system includes a transmitter configured to wirelessly transmit video/audio data streams The transmitter has an encoder module for generating the data streams including video data, audio data, and timing information. The video data includes only I-frames. The transmission system includes a receiver with a decoder module including a decoder IC, an SRAM, and a PLL circuit. The decoder IC detects the timing information, adjusts the PLL circuit to synchronize with a reference frequency, and decodes the data streams using the SRAM. Alternatively, the receiver includes a decoder module with a decoder IC and an SRAM. The decoder IC detects the timing information, generates a beacon pulse to be transmitted wirelessly to the encoder module, and the encoder module receives the beacon pulse, adjusts the PLL circuit incorporated within the encoder module accordingly so as to synchronize with the decoder module.

### CROSS-REFERENCE TO RELATED APPLICATIONS

This application is a continuation-in-part application of U.S. patent application Ser. No. 13/225,485 filed on Sep. 5, 2011, now pending. The content of the above-mentioned patent application is hereby incorporated by reference herein in its entirety and made a part of this specification.

### BACKGROUND OF THE INVENTION

1. Technical Field

The present invention relates to a wireless video/audio data transmission system using I-frame only group of picture (GOP) structure with Phase-Locked Loop (PLL) clock recovery capability. More particularly, this invention relates to a wireless video/audio data transmission system configured to synchronize rate of clock reference information transmitted from a video/audio data stream via PLL circuit disposed in either a decoder module or an encoder module.

2. Description of Related Art

The increasing demand for digital wireless audio/video data presents an ever increasing problem of effectively controlling data transmission in a wireless audio/video transmitter receiver system. As the volume of audio/video data transmission increases in response to greater demand, it becomes increasingly more difficult to handle the large amount of transmitted audio/video information. Conventionally, the data streams contain video, audio, timing information and control data which are packaged and transmitted as a composite whole. The data, control elements, timing information and other information are arranged in various specific formats according to various standards, such as MPEG-1, MPEG-2, MPEG-4, H.264/AVC and others.

For supporting the requirements for high definition television, a High Definition Multimedia Interface (HDMI) receiver is typically used. HDMI receivers support an input reference clock frequency range of 25 MHz to 165 MHz. HDMI is an audio/video interface capable of transmitting uncompressed streams. Typically HDMI provides an interface between any compatible digital audio/video source, such as a set-top box, a DVD player, a PC, a video game console, or an audio video (AV) receiver and a compatible digital audio and/or video display or monitor, such as a high definition television (HDTV).

An important component of the video/audio data stream is the timing information which is used to synchronize the decoding and presentation of the video and audio data. For example, MPEG defines timing information in terms of timestamps or clock references. The MPEG standards permit an encoder to selectively adjust the transmission rate of timestamps in performing its encoding function. One restriction is that the time interval between timestamps must not exceed a specified range. On the other hand, timing information is essential for proper reproduction of the real-time video/audio data stream transmitted wirelessly.

In the conventional video decoder, such as AVC (Advanced Video Coding, also called H.264/MPEG-4 part 10) video decoder, for example, cache memory for frame buffering is usually provided in the form of an off-chip external DDR SDRAM (Double Data Rate Synchronous Dynamic Random-Access Memory). The DDR SDRAM could be a DDR, DDR2, or DDR3 SDRAM. However, the DDR SDRAM adds cost and integrated circuit footprint. Typically only fully-processed or decoded pixel data are stored in the DDR SDRAM, instead of storing frame data in the compressed domain. Video playback is typically at 30 frames per second and at 720 p or 1080 p. Because the frame buffer has a limited memory, thus, only a small number of video frame data can be stored inside the DDR SDRAM. 1080 p is a set of HDTV high-definition video modes characterized by 1080 horizontal lines of vertical resolution and progressive scan.

As described above, the cache buffer or frame buffer needs are typically satisfied at the receiver end by adding more external memory capacity as well as for facilitating display functions in the form of an off-chip DDR SDRAM. Latency from encoding to decoding for conventional video decoders is typically more than 100 milliseconds.

Conventionally, AVC allows for having three different encoded frames, namely, I-frame (also called “Intra-coded picture”), P-frame (also called “Predicted picture”), and B-frame (also called “Bi-predictive picture”), respectively, that are serving different purposes to form a group of picture (GOP) structure. GOP is a group of successive pictures within a coded video stream in which the order of arrangement of the frames are specified. I-frame uses only information in a current frame. P-frame uses information in the current frame and also the previous frames. B-frame uses information in the current frame also the previous frames as well as the later frames thereafter. Typically one group of picture (GOP) usually begins with an I-frame, and is then followed by various configurations of B-frames and P-frames in various allocated combinations. B-frames and P-frames are typically chosen to be used as part of the group of picture structure because of their much higher compression ratios achievable than that of the I-frame.

A Phase Locked Loop (PLL) circuit is an electronic circuit that detects the frequency of an input signal and causes a Voltage-Controlled Oscillator (VCO) to match its output frequency to that of the input signal to effect synchronization. The PLL circuit multiples its reference frequency to a desired output frequency by a ratio of integers. The frequency multiplication is exact, so that the PLL output frequency is precisely locked to the reference frequency. Therefore, if the reference frequency is changed, the output frequency will then track exactly. Conventional Phase-Locked Loop (PLL) circuit typically includes a reference divider, a phase detector, a charge pump, a loop filter, a voltage-controlled oscillator (VCO) and a feedback divider. A post divider is often added for additional flexibility. The PLL circuit works by adjusting the VCO speed faster or slower in response to the input and feedback clocks available at the phase detector inputs. A small value for the feedback and reference dividers increases the rate at which the phase detector is corrected by a clock signal.

For using to correct system clock frequency, a program clock reference (PCR) is found in the packet header of the transport stream, and a system clock reference (SCR) is found in the packet header of a program stream. The PCR and SCR are time reference information for correcting a system clock frequency into a value intended by the encoder. Synchronization of the decoder sections with the channel is accomplished through the use of a program clock reference (PCR) in the transport stream. In other words, the PCR is a timestamp and is used to derive the decoder timing.

Because video decoder module for conventional wireless video/audio transmitter receiver system requires of having an off-chip DDR SDRAM occupying a relatively substantial amount of memory space and requiring added cost to achieve the proper operation of the transmitter receiver system, along with having latency from encoding to decoding for conventional video decoders that takes typically more than 100 milliseconds, which is relatively time consuming, combining with fluctuations in frame sizes and requiring of inter-predication frame buffer when using B-frames; as a result, there is room for improvement in the art.

### SUMMARY OF THE INVENTION

One aspect of the invention is to provide a wireless video/audio data transmission system having the following: a transmitter configured to wirelessly transmit video/audio data streams, the transmitter comprises an encoder module for generating the video/audio data streams, the video/audio data streams include video data, audio data, and timing information, the video data includes only I-frames; a receiver configured to wirelessly receive the video/audio data streams, the receiver comprises a decoder module, the decoder module comprises a decoder IC, an SRAM (Static Random-Access Memory) disposed on the decoder IC, and a PLL (Phase-Locked Loop) circuit to synchronize the rate of clock reference information transmission from a data stream.

One aspect of the invention is to provide a wireless video/audio data transmission system having the following: a transmitter configured to wirelessly transmit video/audio data streams, the transmitter comprises an encoder module for generating the video/audio data streams, the video/audio data streams include video data, audio data, and timing information, the encoder module comprises an encoder IC and a PLL (Phase-Locked Loop) circuit; a receiver configured to wirelessly receive the video/audio data streams, the receiver comprises a decoder module, the decoder module comprises a decoder IC and an SRAM (Static Random-Access Memory) disposed on the decoder IC, wherein the decoder IC detects the timing information in the video/audio data streams, generates a beacon pulse to be transmitted wirelessly to the encoder module, and the encoder module receives the beacon pulse, adjusts the PLL circuit accordingly so as to synchronize with the decoder module.

One aspect of the invention is to provide a wireless video/audio data transmission system having one or more Phase-Locked Loop (PLL) circuits to be adjusted to generate a 27 MHz system clock, and the 27 MHz system clock is used to generate a 148.5 MHz pixel clock to drive a display circuit so as to be able to eliminate the need of requiring a larger frame buffer on the decoder module to decode transmitted 1080 p video frame.

One aspect of the invention is to provide a wireless video/audio data transmission system having a decoder module configured with an SRAM (Static random-access memory) less than 1 Mbytes as a memory buffer including system memory.

One aspect of the invention is to provide the wireless video/audio data transmission system having I-frame only GOP structure and constant bitrate (CBR) rate control to avoid transmission bursting, in which the encoder uses constant bitrate (CBR) rate control to generate the video/audio data streams.

One aspect of the invention is to provide a wireless video/audio data transmission system without using an external DDR SDRAM acting as the frame buffer.

One aspect of the invention is to provide a wireless video/audio data transmission system using an on-chip internal Static Random-Access Memory (SRAM) acting as the frame buffer.

One aspect of the invention is to provide a wireless video/audio data transmission system for processing pixel data or frame images under compressed domain using the on-chip SRAM memory disposed on the decoder IC (Integrated Circuit, also referred to as a chip, or a microchip).

To achieve the foregoing and other aspects, the synchronization of the reference frequency in the decoder module with the reference frequency in the encoder module allows for having a smaller frame buffer in the form of an on-chip SRAM memory to be effectively utilized without having problems relating to displaying faulty images. Moreover, by synchronizing the reference frequency in the decoder module with the reference frequency in the encoder module, the frame buffer size can be effectively optimized to the extent that even the smaller frame buffer capacity of the SRAM disposed on-chip can be used to adequately and effectively support the needs for cache memory of the video decoder module without requiring of having a larger off-chip DDR SDRAM.

To achieve the foregoing and other aspects, underflow issues in the cache memory or frame buffer would be overcome by speeding up the encoder clock at the transmitter according to a message (e.g., a control signal) periodically sent from the decoder module.

To achieve the foregoing and other aspects, wireless transmission of video/audio data streams at for example 1080 p are utilized.

To achieve the foregoing and other aspects, a PLL circuit is configured to resolve discrepancies in reference frequency synchronization between the encoder and decoder modules caused by fluctuating time delay.

To achieve the foregoing and other aspects, the PLL circuit residing at the decoder module is configured for adjusting the reference frequency in the decoder module with respect to the reference frequency in the encoder module so as to be synchronized.

To achieve the foregoing and other aspects, the PLL circuit disposed within the decoder module is adjusted up when the reference frequency of the encoder module is too high by a first predefined amount, and the PLL circuit disposed within the decoder module is adjusted down when the reference frequency of the encoder module is too low by a second predefined amount.

To achieve the foregoing and other aspects, the PLL circuit disposed within the encoder module is adjusted up when the reference frequency of the decoder module is too high by a first predefined amount, and the PLL circuit disposed within the decoder module is adjusted down when the reference frequency of the decoder module is too low by a second predefined amount.

To achieve the foregoing and other aspects, the SRAM is disposed on the decoder IC of the decoder module.

To achieve the foregoing and other aspects, a plurality of timestamps, each sent at a set interval in the packet header is provided. The decoder detects the timestamps in the video/audio data stream and determines whether to maintain, adjust up, or adjust down the PLL circuit for proper decoding. In addition, the PLL circuit is used to synchronize an outputted 27 MHz system clock with an input transport stream 27 MHz clock from the encoder module and it is derived by the post divider to output pixel clock at a total sampling rate of 148.5 MHz to drive the display circuit.

To achieve the foregoing and other aspects, a plurality of counters used at the encoder and decoder modules are of 33 bits counters containing the timestamp values.

To achieve the foregoing and other aspects, the PLL circuit includes a reference divider, a phase detector, a charge pump, a loop filter, a voltage-controlled oscillator (VCO) and a feedback divider. The PLL circuit works by adjusting the VCO speed faster or slower in response to the input and feedback clocks available at the phase detector inputs. A small value for the feedback and reference dividers increases the rate at which the phase detector is corrected by a clock signal.

To achieve the foregoing and other aspects, a High-Definition Multimedia Interface (HDMI) I/O connector for transmitting uncompressed streams is provided between a compatible digital audio/video source, such as a set-top box, a DVD player, a PC, a video game console, or an audio video (AV) receiver and a compatible digital audio and/or video monitor, such as a digital television (DTV) to the decoder module at the receiver.

To achieve the foregoing and other aspects, a control logic generates a beacon pulse to be transmitted wirelessly as a control signal from the decoder module to the encoder module at a regular, predetermined period of the decoder local clock. The encoder module receives the beacon pulse, adjusts its PLL circuit and changes its reference frequency to synchronize with the reference frequency of the decoder module accordingly.

To achieve the foregoing and other aspects, the decoder module uses a local clock to determine the timing of the data stream according to the timestamps value, and the encoder local clock and the decoder local clock are synchronized.

To achieve the foregoing and other aspects, the wireless encoder module and decoder module may communicate uni-directionally or bi-directionally.

To achieve the foregoing and other aspects, synchronization of the decoder sections with the channel is accomplished through the use of a program clock reference (PCR) in the transport stream. The PCR is a timestamp and is used to derive the decoder timing.

The embodiment supports 1080 p video streaming rate at 60 fps for performing wireless transmission being capable of super low latency, having lower memory using a smaller sized SRAM instead of a larger sized DDR SDRAM, and achieving superior video quality. In addition, the embodiment uses all I-frames (I-frames only) to eliminate the inter-predication frame buffer required by other types of frames to reduce memory requirement, and the SRAM may need only about 5 macroblock (MB) rows of working memory, that is with 460,800 bytes capacity, to be able to function properly. Each of the I-frames includes a plurality of slices, and each slice includes a plurality of macroblocks, and the decoder module performs decoding of the video/audio data streams based on the slices. In addition, the size of the slice is configurable.

To achieve the foregoing and other aspects, a decoder module for wirelessly receiving video/audio data streams generated by an encoder module is provided. The video/audio data streams include timing information provided by the encoder module. The decoder module includes a decoder IC; an SRAM (Static Random-Access Memory) disposed on the decoder IC; a PLL (Phase-Locked Loop) circuit. The decoder IC detects the timing information in the video/audio data streams, adjusts the PLL circuit to synchronize with a reference frequency of the encoder module, and decodes the video/audio data streams using the SRAM without using a DRAM (Dynamic Random-Access Memory) external to the decoder IC. The PLL circuit is adjusted up when the reference frequency of the encoder module is too high by a first predefined amount, and the PLL circuit is adjusted down when the reference frequency of the encoder module is too low by a second predefined amount. In addition, when the decoder IC decodes the video/audio data streams, the decoder IC stores pixel data in compressed domain in the SRAM. Meanwhile, the video/audio data streams include only I-frames, and are generated by the encoder module based on constant bitrate (CBR) rate control.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a block diagram showing a wireless video/audio transmission system according to a first embodiment.

FIG. 2 is a block diagram showing a conventional PLL having a Voltage-Controlled Oscillator (VCO).

FIG. 3a-3b are block diagrams showing timing information being defined in terms of timestamps, in which each timestamp is sent at set intervals in the packet header for detecting timing difference.

FIG. 4 is a block diagram showing a control logic generating a beacon pulse to be transmitted wirelessly as a control signal from the decoder module to the encoder module at a regular, predetermined period, according to an alternative embodiment.

FIG. 5 is a block diagram showing a decoder module which includes a video decoder section and an audio decoder section according to a second embodiment.

FIG. 6 is a block diagram showing a wireless video/audio transmission system having an encoder module supporting MPEG-4, Advanced Video Coding, High 4:4:4 Intra Profile according to a third embodiment of present application.

FIG. 7 is a block diagram showing a PLL circuit according to an embodiment of present application.

FIG. 8 is a block diagram showing a pipeline design for data processing of the third embodiment.

FIGS. 9A, 9B, and 9C show a GOP structure having only I-frames with four modes of 16×16 macroblocks and nine modes of 4×4 macroblocks intracoding of the third embodiment.

FIG. 10 shows one slice per row of macroblocks being adopted for the third embodiment as illustration of having multiple slices per frame.

FIG. 11 shows a representation of the latency at the encoder module T1, during transportation T3 and at the decoder module T2.

### DETAILED DESCRIPTION OF THE INVENTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

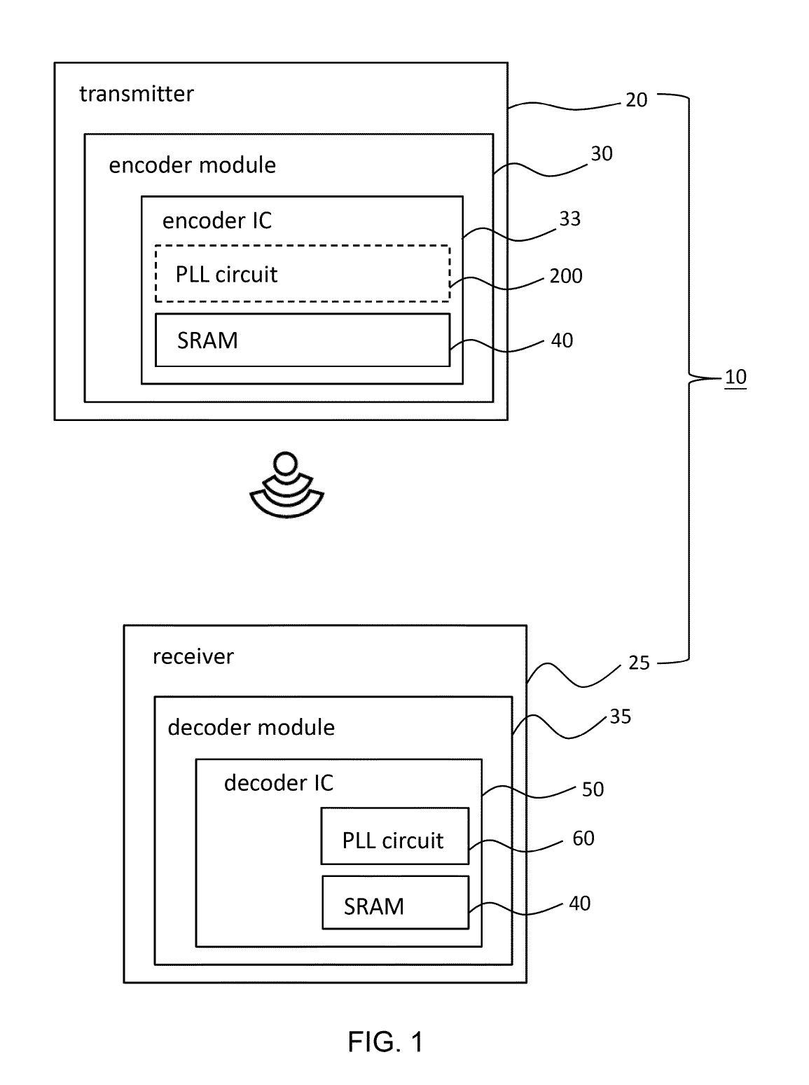

According to a first embodiment of present application, a wireless video/audio transmission system 10 is provided. Referring to FIG. 1, the wireless video/audio transmission system 10 includes a transmitter 20 and a receiver 25. The transmitter 20 includes an encoder module 30, and the receiver 25 includes a decoder module 35. The transmitter 20 may be attached to or be incorporated within an electronic device (not shown) which contains a plurality of video/audio data ready for playback wirelessly through the transmitter 20 to the receiver 25. The receiver 25 may be connected to or be incorporated within a display device (not shown) such as an HDTV, ready for video audio playback. The decoder module 35 provides video playback at 60 frames per second at 1080 p. The video/audio data streams are wirelessly transmitted between the encoder module 30 and the decoder module 35. The time delay may fluctuate over time, thereby causing discrepancies in frequency synchronization between the encoder module 30 and the decoder module 35. An SRAM (Static Random-Access Memory) 40 is disposed on a decoder IC 50 (on-chip SRAM) in the decoder module 35. In the first embodiment, there is no off-chip DDR SDRAM (Double Data Rate Synchronous Dynamic Random-Access Memory) (not shown) in the decoder module 35, thus the overall IC footprint of the decoder module 35 may be reduced.

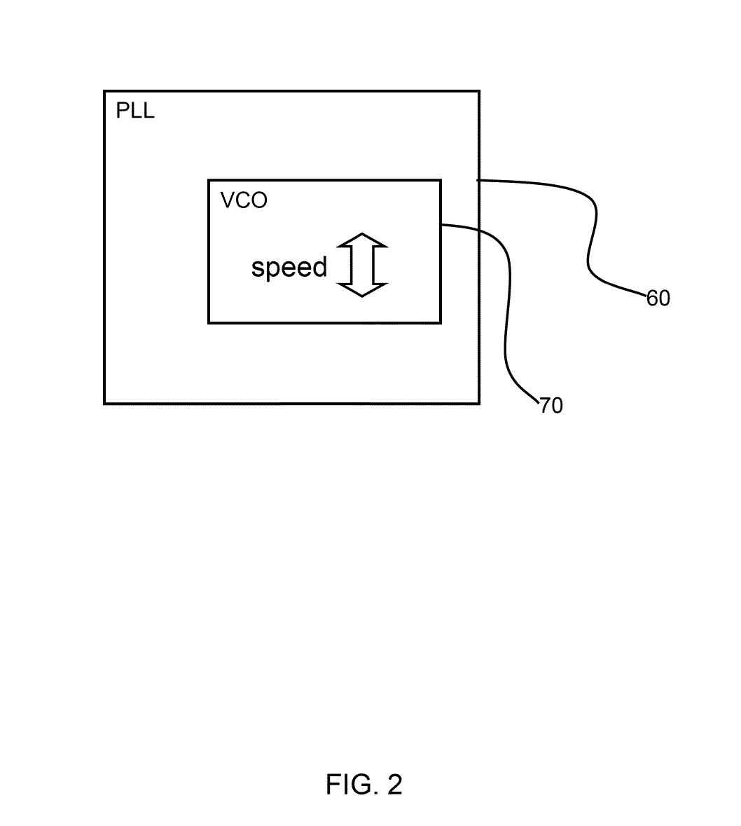

Referring again to FIG. 1, a PLL circuit 60 is configured in the decoder IC 50 of the decoder module 35. Referring to FIG. 2, the PLL circuit 60 may be a conventional PLL, which can adjust a voltage-controlled oscillator (VCO) to go faster or slower. In the first embodiment, the PLL circuit 60 includes a reference divider (not shown), a phase detector (not shown), a charge pump (not shown), a loop filter (not shown), a voltage-controlled oscillator 70 and a feedback divider (not shown). In another embodiment, a post divider (not shown) is added for additional flexibility. The PLL circuit 60 works by adjusting the VCO 70 speed faster or slower in response to the input and feedback clocks available at the phase detector inputs. A small value for the feedback and reference dividers increases the rate at which the phase detector is corrected by a clock signal. In the embodiments, the PLL circuit 60 is configured to adjust a reference frequency value in the decoder module 35, so that the reference frequency in the decoder module 35 may synchronize with the reference frequency in the encoder module 30. The decoder module 35 may achieve such synchronization by referring to the timing information in the video/audio data stream received by the decoder module 35. The decoder module 35 may detect the timestamps in the video/audio data stream to obtain the reference frequency in the encoder module 30 and perform video/audio decoding. In this embodiment, the PLL circuit 60 is incorporated within the decoder module 35. It is noted that the PLL circuit may instead be incorporated within the encoder module 30, as shown in FIG. 1 as PLL circuit 200. In such case, the decoder module 35 informs the encoder module 30 so that the encoder module 30 may adjust the PLL circuit 200 and change its reference frequency to synchronize with the reference frequency of the decoder module 35 accordingly.

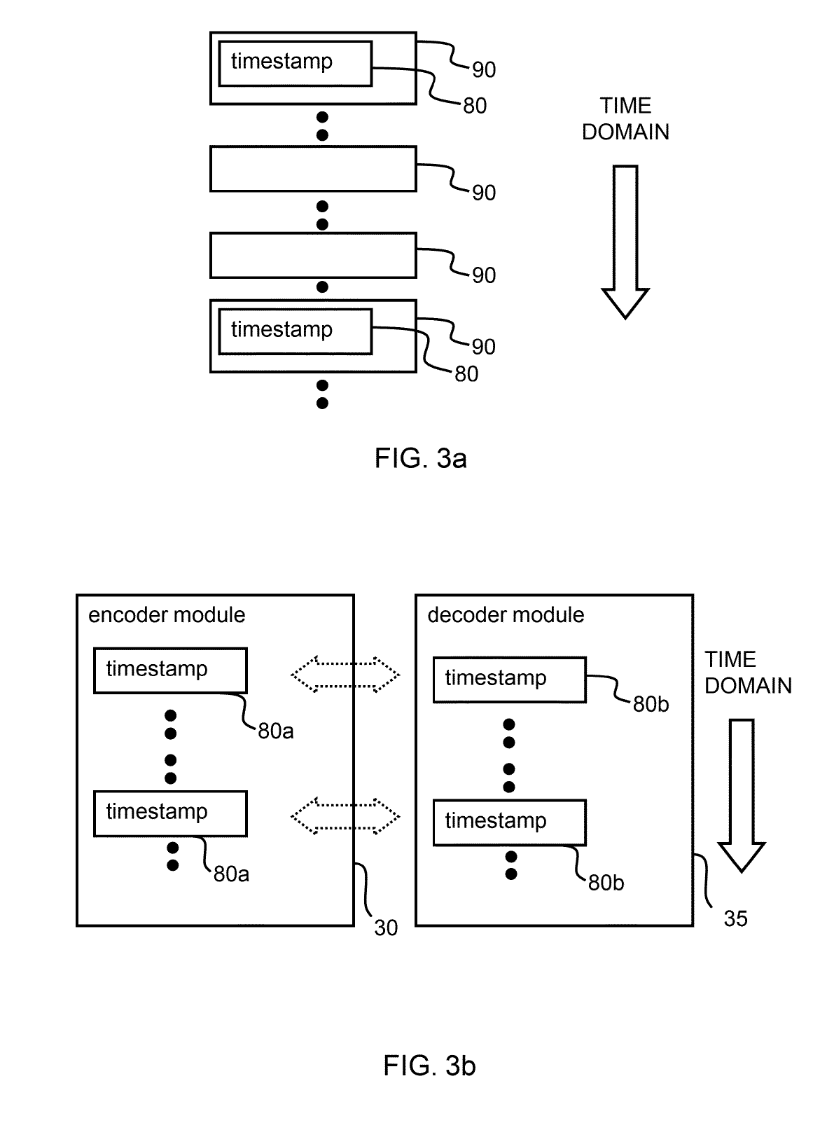

In the first embodiment, the system clock oscillates with +/−30 ppm tolerance. In addition, in the embodiments of instant disclosure, a plurality of data streams contain video, audio, timing information and control data are packaged and transmitted as a composite whole. The data, control elements, timing information and other information are arranged in accordance with AVC (Advanced Video Coding, H.264/MPEG-4 part 10) standard. The timing information is used to synchronize the decoding and presentation of the video and audio data. Referring to FIGS. 3a-3b, in the embodiments, the timing information is defined in terms of a plurality of timestamps 80. Moreover, each timestamp 80 is sent at 10 millisecond intervals, for example, in the packet header for detecting timing difference. It should be noted that the timestamp 80 is not found in every packet 90, but is instead configured in set interval of 10 milliseconds in the first embodiment, but is not limited to that, and can be configured at various time intervals depending upon specific requirements. A counter is set to count according to 27 MHz frequency to compare a local counter timestamp 80a. Based on the differences between the local counter timestamp values 80a, 80b in the encoder module 30 and the decoder module 35, the PLL 60 disposed at the decoder IC 50 can be adjusted up when the reference frequency of the encoder module 30 is too high by a first predefined amount and the corresponding timestamp 80a value at the encoder module 30 is too low in comparison to the corresponding timestamp 80b value at the decoder module 35 by a second predefined amount. In addition, the PLL 60 at the decoder module 35 can be adjusted down when the reference frequency of the encoder module 30 is too low by a first predefined amount and the corresponding timestamp 80a at the encoder module 30 is too high in comparison to the corresponding timestamp 80b value at the decoder module 35 by a second predefined amount. In the first embodiment, the counters used at the encoder module 30 and the decoder module 35 are of 33 bits containing the timestamp 80 values. In short, when the encoder module 30 is too fast, the PLL 60 (in the decoder module 35) is then adjusted higher. Then when the encoder module 30 is too slow, the PLL 60 is adjusted lower. The timestamp 80 is found in the frame header (not shown). It is noted that there is no requirement for having any display memory to be stored in any off-chip DDR SDRAM according to the embodiments of instant application. Therefore, the PLL circuit 60 is able to effectively provide synchronization between the frequencies at the encoder module 30 and the decoder modules 35 without requiring a large cache buffer such as that generally provided by a conventional off-chip DDR SDRAM.

According to the embodiments of the instant application, a large external DDR SDRAM (including a DDR, DDR2, DDR3 SDRAM) acting as the frame buffer is omitted, and instead at least one SRAM 40 is found in the decoder module 35. The SRAM 40 is a small on-chip internal SRAM disposed on the decoder IC 50. The operating performance of the SRAM 40 is faster than the DDR SDRAM. According to one embodiment, transmission latency from encoding to decoding for using the SRAM 40 may be achieved to be around 50 milliseconds as compared to the transmission latency of conventional system using DDR SDRAM to be around 100 milliseconds. According to alternative embodiments, the frame buffer or cache can be implemented with a custom voltage scalable SRAM to minimize memory access power, and the SRAM 40 can be a single-port on-chip SRAM cache disposed on the decoder IC 50.

In the first embodiment, the receiver 25 is a receiver with an HDMI interface which supports an input reference clock frequency range of 25 MHz to 165 MHz. In the first embodiment, the encoder module 30 at the transmitter 20 is a wireless module, and generates a local clock, the cycles of the local clock is counted during a common timing reference period maintained wirelessly between the encoder module 30 and the decoder module 35, a timestamp 80 of the decoder clock is received during the same common timing reference period, and the local clock signal of the encoder module 30 is then adjusted based upon a comparison of the two timestamps 80a, 80b (of the encoder clock with respect to the decoder clock). For the first embodiment, the wireless decoder module 35 further receives timing references from the encoder module 30 and, in addition, receives packets of data samples from the encoder module 30 accompanied by a timestamp 80 in which the timestamp 80 is based upon the encoder timing reference, and outputs the data sample at the time designated by the timestamp 80. In the embodiments, the wireless encoder module 30 and the wireless decoder module 35 may communicate unidirectionally or bidirectionally.

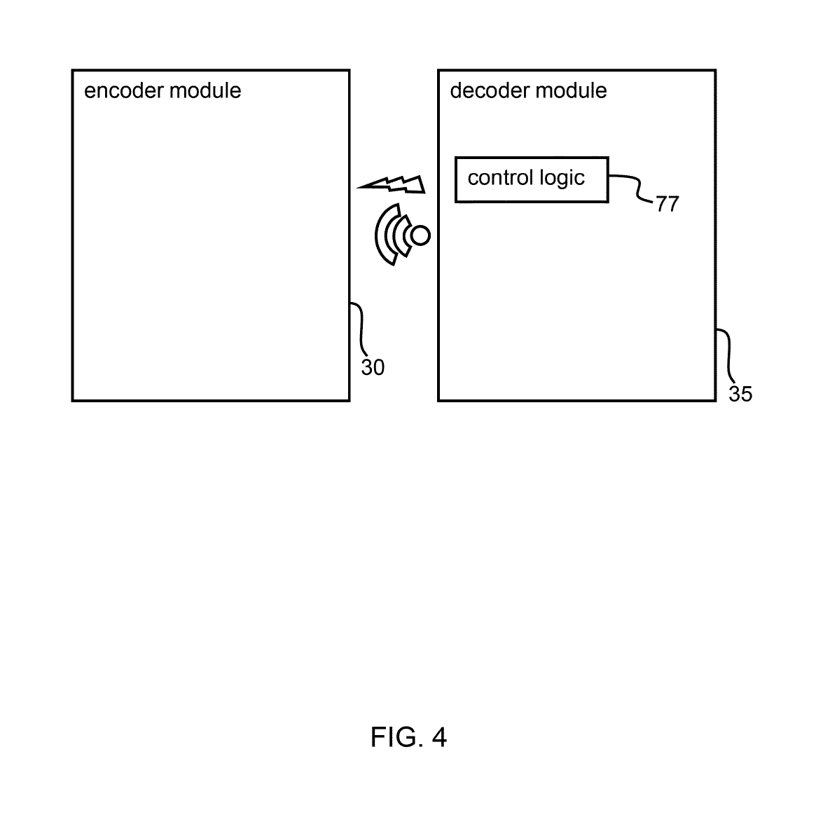

Referring to FIG. 4, for an alternative embodiment where the PLL circuit 200 is configured in the encoder module 30, a control logic 77 generates a beacon pulse to be transmitted wirelessly as a control signal from the decoder module 35 to the encoder module 30 at a regular, predetermined period of the decoder local clock. The encoder module 30 receives the beacon pulse, adjusts the PLL circuit 200 and changes its reference frequency to synchronize with the reference frequency of the decoder module 35 accordingly. In addition, the wireless video/audio transmission system 10 can be a wireless video/audio data transmission gateway device, for example.

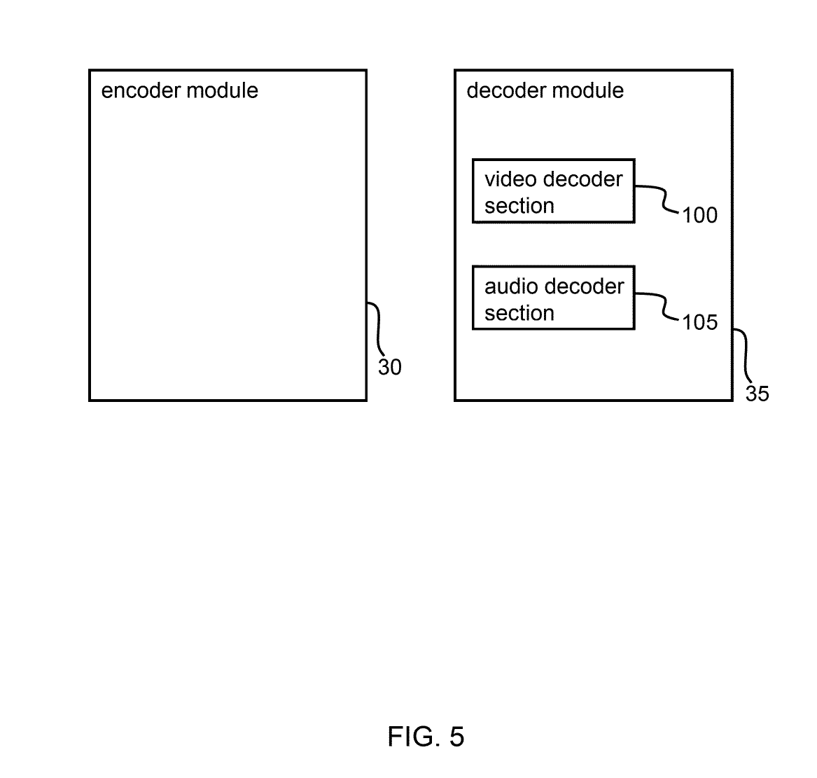

In a second embodiment, video data and audio data are encoded into a plurality of elementary video and audio bitstreams at the encoder module 30. These bitstreams are then converted into packets. The packets are multiplexed to produce a transport stream. The transport stream is transmitted over a transmission channel, which may further incorporate separate channel for specific encoder and decoder (not shown). Next, the transport stream is demultiplexed and decoded by a transport stream demultiplexor (not shown), where the elementary bitstreams serve as inputs to the decoder module 35. Referring to FIG. 5, the decoder module 35 includes a video decoder section 100 and an audio decoder section 105, whose outputs are decoded video signals on path and audio signals on path respectively. Furthermore, timing information is also extracted by the transport stream demultiplexor and delivered to the clock control for synchronizing the video decoder section 100 and the audio decoder section 105 with each other and with the channel. In this embodiment, synchronization of the decoder sections 100, 105 with the channel is accomplished through the use of the PCR in the transport stream. The PCR is a timestamp 80. More specifically, clock control incorporates the PLL circuit 60 which evaluates the PCR to effect adjustment of the VCO 70, thereby achieving synchronization. Initialization sets the value in the counter of the decoder module 35 to be equal to that of the value of the counter of the encoder module 30. When the reference frequency of the decoder module 35 is synchronized with the encoder module 30, both counters containing their respective timestamp values 80a, 80b are counting synchronously.

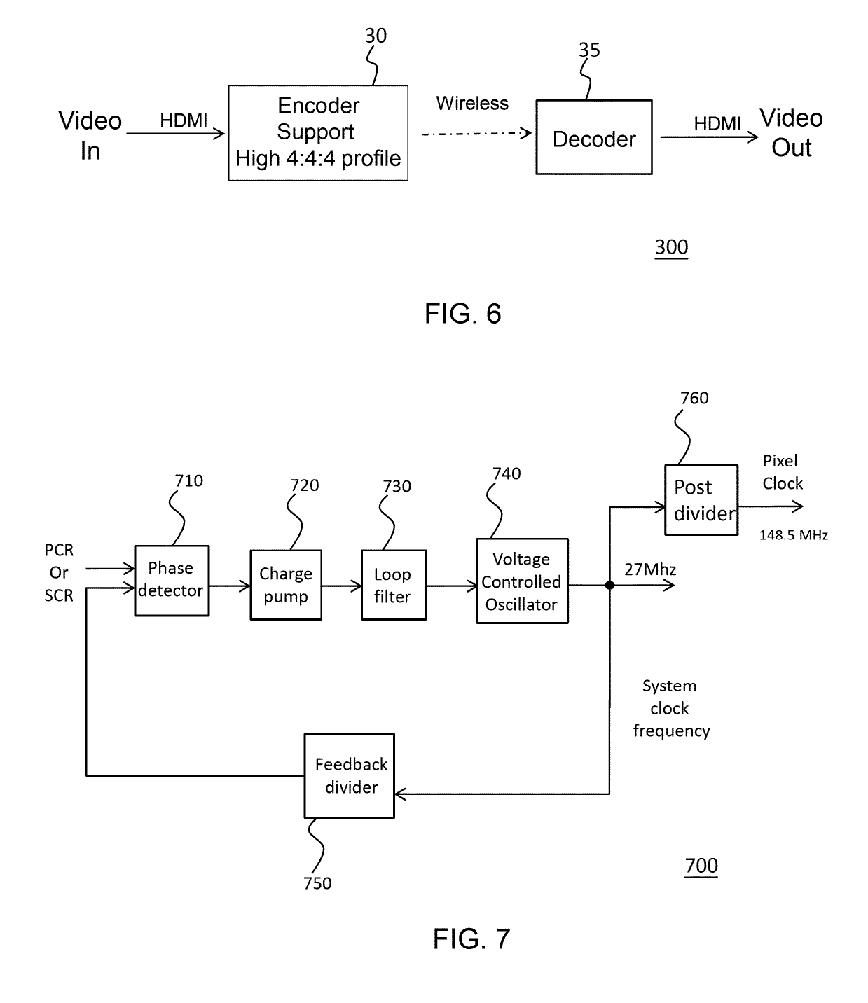

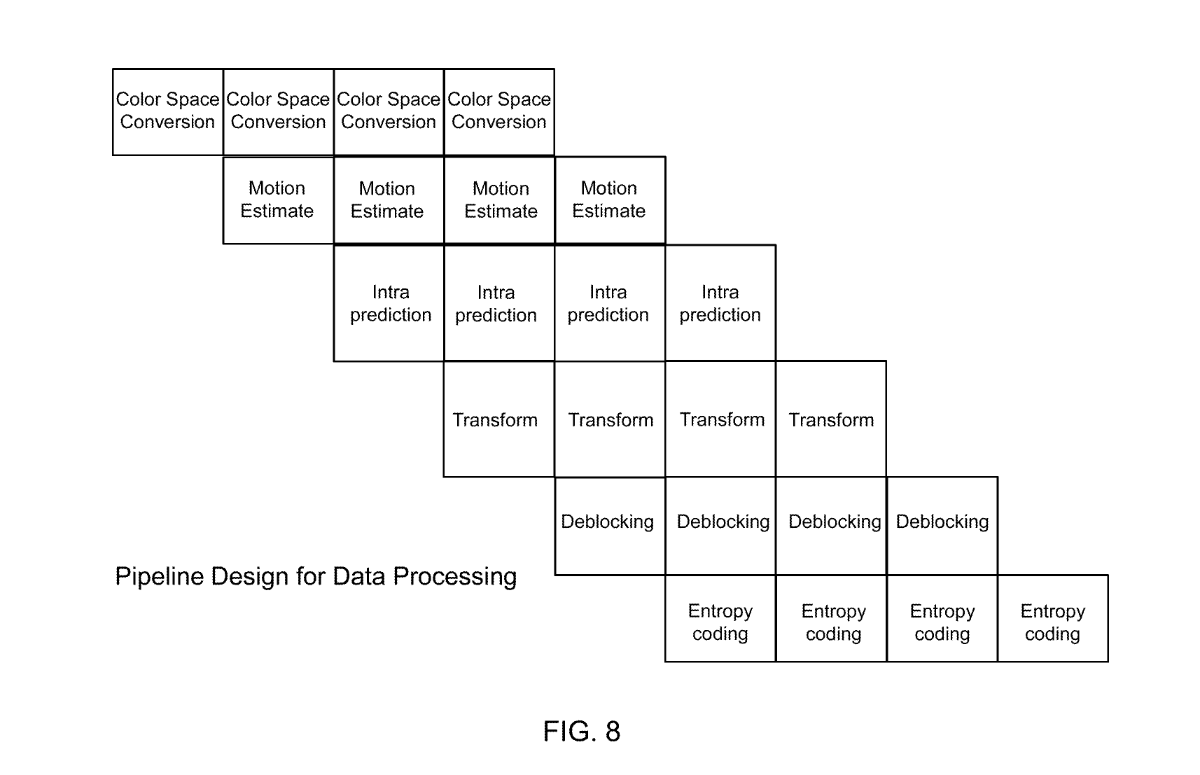

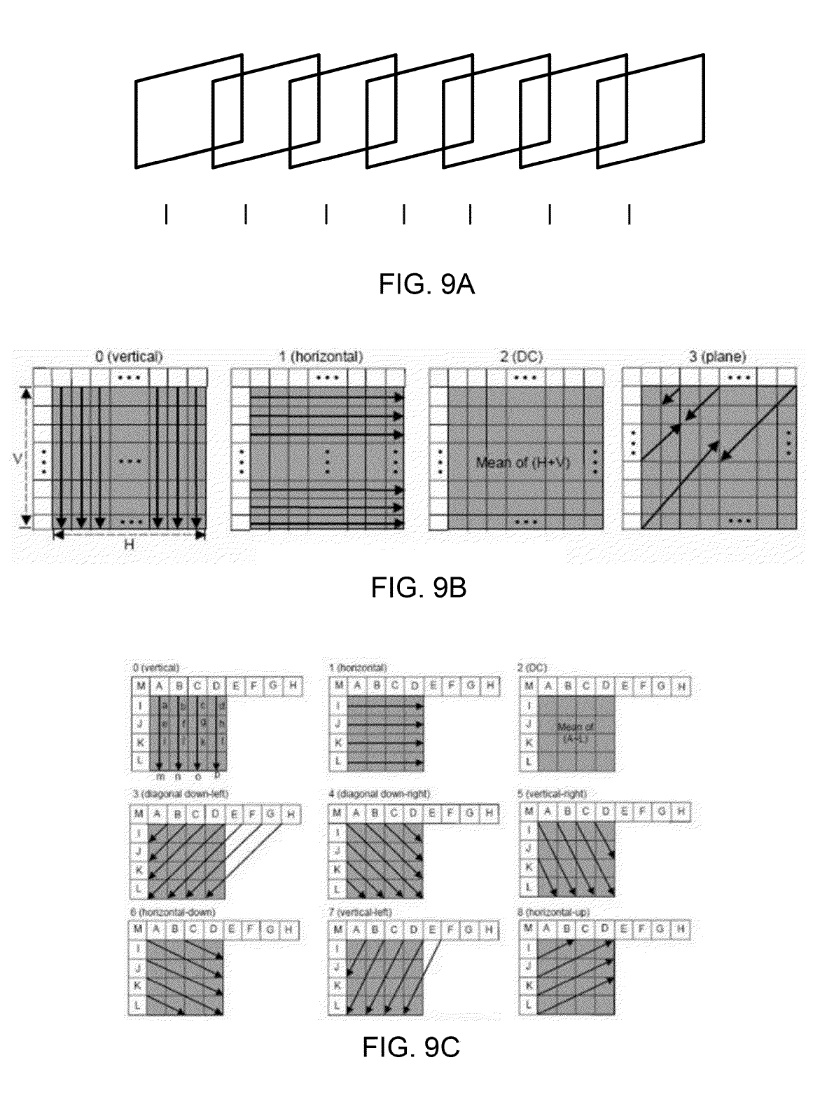

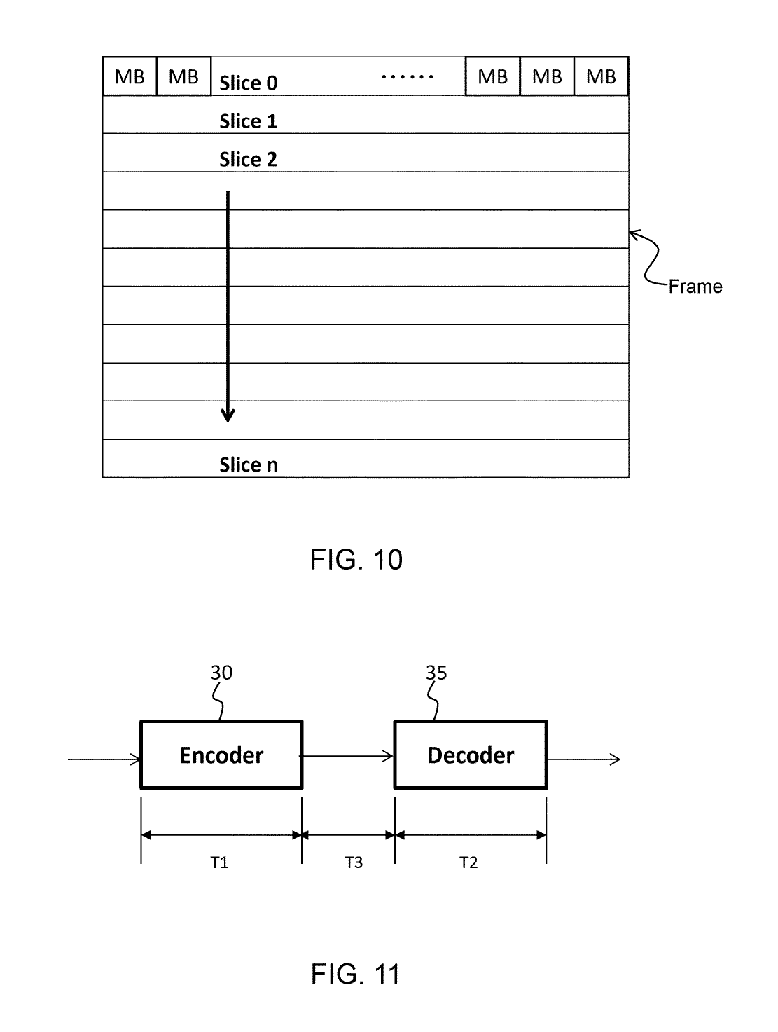

According to a third embodiment, as shown in FIG. 6, video streaming transmission is conducted at 1080 p resolution at 60 fps (frames per second) frame rate by a wireless video/audio transmission system 300 having an encoder module 30 supporting MPEG-4 (also called “ISO/IEC 14496”, or “MPEG-4 Part 2”), AVC (Advanced Video Coding, also called “H.264/MPEG-4 Part 10”), High 4:4:4 Intra Profile (the High 4:4:4 Profile constrained to all-Intra use) in which the streaming video contains image frames which are all I-frames. In this illustrated embodiment, the video stream is transmitted under MPEG-4 AVC, High 4:4:4 Intra Profile at about 200˜300 Mbps bitrate, which is thereby suitable for 802.11n WiFi & UWB transmission. Referring to FIG. 8, a pipeline design for data processing of the streaming video data of the wireless video/audio transmission system 300 according to the third embodiment includes the following tasks: color space conversion, motion estimate, intra prediction, transform, deblocking filter, and entropy coding. The streaming video is processed through the pipeline design accordingly. As shown in FIG. 9A, only I-frames are used for all of the respective encoded or compressed frames (i.e. without using any B-frame or P-frame in the group of picture structure), and thus a group of picture (GOP) begins with an I-frame and is followed with all I-frames without using any P frame or any B frame, thereby eliminating the inter-predication frame buffer required for temporal reference. Referring to FIG. 9B, there are four prediction modes possible for encoding 16×16 blocks. The four modes are 0 (vertical), 1 (horizontal), 2 (DC) and 3 (plane). Referring to FIG. 9C, there are nine prediction modes possible for encoding 4×4 blocks. The nine modes are 0 (vertical), 1 (horizontal), 2 (DC), 3 (diagonal down left), 4 (diagonal down right), 5 (vertical left), 6 (vertical right), 7 (horizontal down), and 8 (horizontal up). The obtained average Peak signal-to-noise ratio (PSNR) is above 45 dB, thereby qualifies as visually lossless. The present embodiment supports High 4:4:4 Intra profile, where all coloring spaces are preserved, and is thereby ideal for use by wireless monitor and suitable for other professional wireless video transmission applications. As shown in FIG. 10, in the present embodiment, to reduce end-to-end latency, a frame is split into multiple slices, and each slice includes one row of macroblocks (MB). It is noted that the size for each slice may be configurable. In other embodiments, each slice may contain less than one (for example, one half or one third) row of macroblocks, or may contain multiple rows of macroblocks. The decoder module 35 supports slice decoding (i.e., decoding based on slices, instead of frames) and real-time partial frame buffer display to reduce the end-to-end latency (excluding transportation latency) down to 2 ms. In order to avoid frame buffer underrun or overrun problem on the decoder module 35, the PLL circuit 700 as shown in FIG. 7 is provided and configured to synchronize a transmitting side 27 MHz PCR clock and its derived pixel clock, without thereby requiring the need for having a larger frame buffer residing on the decoder module side to decode the transmitted 1080 p video frame and without producing buffer transmission jitters, and the total size of buffer memory of the SRAM 40, including system memory, could be less than 1 Mbytes. In short, the present embodiment uses I-frame only GOP structure and CBR (Constant Bitrate) rate control to avoid transmission bursting. In the third embodiment, five (5) macro block rows working memory of 460,800 bytes is used for YUV 4:4:4 chroma format. The calculation for total memory size requirement for the 5 macro block rows working memory is described as follow: 1,920 pixels in width×16 pixels/macroblock×5 macroblock rows×3 bytes/one pixel storage=460,800 bytes In the instant embodiment, AVC-Intra/Ultra specification is followed.

Referring to FIG. 11, encoder latency is expressed as T1, latency during transportation is expressed as T3 and decoder latency is expressed as T2. Total latency is defined to be summation of T1, T2 and T3.

Total latency=T1+T2+T3.

In the present (third) embodiment, latency analysis is conducted as follow: measuring from the input of scan line to the output of NAL (Network Abstraction Layer) bytes, the encoder latency is measured to be 0.502 ms for T1. Latency is measured by adding one macroblock row processing time to 3 macroblocks processing time. Decoder latency is measured to be also 0.502 ms (T2, measured from the arrival of NAL stream to output frame buffer). When using the multiple slice design as shown in FIG. 10, the back-to-back encoder and decoder total latency is 1.1 ms together with 2 slices duration (of T1+T2 only, and excluding a transportation latency T3). Total latency from the encoder to the decoder is determined to be as follow:

Encoder and decoder total latency=1.1 ms+2 slices duration

For 30 fps frame rate, at 10 slices per frame, latency is calculated as follow:

Latency=1.1 ms+2*(1000 ms/30/10)=7.7 ms.

For 60 fps at 20 slices per frame, latency is calculated as follow:

Latency=1.1 ms+2*(1000 ms/60/20)=2.775 ms.

In an alternative embodiment, redundant slices are utilized for error resilience. AVC specifications provide teachings for the usage of redundant slices.

FIG. 7 is a block diagram of an example of the PLL circuit 60 disposed in the decoder module 35. The PLL circuit 700 includes a phase detector 710, a charge pump 720, a loop filter 730, a voltage controlled oscillator 740, a feedback divider 750, and a post divider 760. The PLL circuit 700 is disposed in the decoder module 35, and may also be optionally incorporated within the decoder IC 50. The PCR or SCR are information for correcting a system clock frequency into a value intended by the encoder module 30. In the illustrated embodiment, the PCR or SCR can be inputted and fed to the phase detector 710. The PCR or SCR embedded in the stream and the system clock frequency processed by the feedback divider 750 are fed into the phase detector 710. The phase detector 710 compares the two input signals and produces an error signal proportional to their phase difference. The error signal is then filtered and used to drive the voltage controlled oscillator 740 to generate a 27 MHz system clock frequency. The 27 MHz output is fed through the feedback divider 750 to the input of the phase detector 710. After a period of time of processing, the outputted 27 MHz system clock will be synchronized with the input transport stream 27 MHz clock from the encoder module, and the post divider 760 generates a pixel clock at a total sampling rate of 148.5 MHz to drive the display circuit. In another embodiment, the phase detector 710 may be implemented by software. In such case, the phase detector 710 may retrieve the 27 MHz system clock frequency value from a register in the post divider 760, compare it against the PCR or SCR value embedded in the stream, and produce an error signal value proportional to their phase difference. The error signal value may be stored into a register in the loop filter 730. The clock frequency value may be a counter value instead of a signal event as edge. For the alternative embodiment where the decoder module 35 provides a beacon pulse as a control signal to the encoder module 30, the PLL circuit 700 in FIG. 7 may also be used as the PLL circuit 200 disposed in the encoder module 33, and may also be optionally incorporated within the encoder IC 33.

According to the embodiments of instant application, overall memory usage for the wireless video/audio transmission system is reduced by omitting a large external DDR SDRAM acting as the frame buffer. Instead, a much smaller internal SRAM is used. As a result, the quantity of memory components for the wireless video/audio transmission system is reduced by eliminating the DDR SDRAM. In the conventional art, only fully-processed pixels are stored in the off-chip DDR SDRAM. On the other hand, pixel data in compressed domain are stored in the SRAM 40 according to the embodiments of instant application. By using I-frame only GOP structure, fluctuation in frame sizes are reduced. By using multiple slices, the waiting time in the decoder module are reduced. In addition, constant bitrate (CBR) control algorithms guarantees smoothness in bitrate. Moreover, additional advantages of the embodiments also include minimized jitter and delay in transport layer, and thus end-to-end latency is much reduced.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A wireless video/audio transmission system, comprising:
a transmitter configured to wirelessly transmit video/audio data streams, the transmitter comprises an encoder module for generating the video/audio data streams, the video/audio data streams include video data, audio data, and timing information, the video data includes only I-frames;
a receiver configured to wirelessly receive the video/audio data streams, the receiver comprises a decoder module, the decoder module comprises a decoder IC, an SRAM (Static Random-Access Memory) disposed on the decoder IC, and a PLL (Phase-Locked Loop) circuit,
wherein the decoder IC detects the timing information in the video/audio data streams, adjusts the PLL circuit to synchronize with a reference frequency of the encoder module, and decodes the video/audio data streams using the SRAM.

2. The wireless video/audio transmission system of claim 1, wherein the encoder uses constant titrate (CBR) rate control to generate the video/audio data streams.

3. The wireless video/audio transmission system of claim 1, wherein the decoder IC decodes the video/audio data streams without using a DRAM (Dynamic Random-Access Memory) external to the decoder IC.

4. The wireless video/audio transmission system of claim 1, wherein the PLL circuit is adjusted up when the reference frequency of the encoder module is too high by a first predefined amount, and the PLL circuit is adjusted down when the reference frequency of the encoder module is too low by a second predefined amount.

5. The wireless video/audio transmission system of claim 1, wherein when the decoder IC decodes the video/audio data streams, the decoder IC stores pixel data in compressed domain in the SRAM.

6. The wireless video/audio transmission system of claim 1, wherein each of the I-frames includes a plurality of slices, and each slice includes a plurality of macroblocks, and the decoder module performs decoding of the video/audio data streams based on the slices.

7. The wireless video/audio transmission system of claim 6, wherein a size of the slice is configurable.

8. The wireless video/audio transmission system of claim 6, wherein the decoder module supports real-time partial frame buffer display.

9. The wireless video/audio transmission system of claim 1, wherein the PLL circuit is adjusted to generate a 27 MHz system clock, and the 27 MHz system clock is used to generate a 148.5 MHz pixel clock to drive a display circuit.

10. A wireless video/audio transmission system, comprising:
a transmitter configured to wirelessly transmit video/audio data streams, the transmitter comprises an encoder module for generating the video/audio data streams, the video/audio data streams include video data, audio data, and timing information, the encoder module comprises an encoder IC and a PLL (Phase-Locked Loop) circuit;
a receiver configured to wirelessly receive the video/audio data streams, the receiver comprises a decoder module, the decoder module comprises a decoder IC and an SRAM (Static Random-Access Memory) disposed on the decoder IC,
wherein the decoder IC detects the timing information in the video/audio data streams, generates a beacon pulse to be transmitted wirelessly to the encoder module, and the encoder module receives the beacon pulse, adjusts the PLL circuit accordingly so as to synchronize with the decoder module.

11. The wireless video/audio transmission system of claim 10, wherein the decoder module includes a control logic for generating the beacon pulse at a regular, predetermined period.

12. The wireless video/audio transmission system of claim 10, wherein the decoder IC decodes the video/audio data streams using the SRAM without using a DRAM (Dynamic Random-Access Memory) external to the decoder IC.

13. The wireless video/audio transmission system of claim 10, wherein the encoder uses constant bitrate (CBR) rate control to generate the video/audio data streams.

14. The wireless video/audio transmission system of claim 10, wherein the PLL circuit is adjusted up when the reference frequency of the decoder module is too high by a first predefined amount, and the PLL circuit is adjusted down when the reference frequency of the decoder module is too low by a second predefined amount.

15. The wireless video/audio transmission system of claim 10, wherein when the decoder IC decodes the video/audio data streams, the decoder IC stores pixel data in compressed domain in the SRAM.

16. The wireless video/audio transmission system of claim 10, wherein each I-frame includes a plurality of slices, and each slice includes a plurality of macroblocks, and the decoder module performs decoding of the video/audio data streams based on the slices.

17. A decoder module for wirelessly receiving video/audio data streams generated by an encoder module, the video/audio data streams including timing information provided by the encoder module, the decoder module comprising:
a decoder IC;
an SRAM (Static Random-Access Memory) disposed on the decoder IC;
a PLL (Phase-Locked Loop) circuit;
wherein the decoder IC detects the timing information in the video/audio data streams, adjusts the PLL circuit to synchronize with a reference frequency of the encoder module, and decodes the video/audio data streams using the SRAM without using a DRAM (Dynamic Random-Access Memory) external to the decoder IC.

18. The decoder module of claim 17, wherein the PLL circuit is adjusted up when the reference frequency of the encoder module is too high by a first predefined amount, and the PLL circuit is adjusted down when the reference frequency of the encoder module is too low by a second predefined amount.

19. The decoder module of claim 17, wherein when the decoder IC decodes the video/audio data streams, the decoder IC stores pixel data in compressed domain in the SRAM.

20. The decoder module of claim 17, wherein the video/audio data streams include only I-frames, and are generated by the encoder module based on constant titrate (CBR) rate control.
